(19) United States
(12) Patent Application Publication
(10) Pub. No.: US 2007/0090576 A1
(43) Pub. Date: Apr. 26, 2007

(54) Process for forming a container opening

(75) Inventors: Johannes Geser, Ingelheim (DE); Torsten Kuehn, Appenheim (DE)

Correspondence Address: MICHAEL P. MORRIS;BOEHRINGER INGELHEIM CORPORATION, 900 RIDGEBURY RD, P. O. BOX 368, RIDGEFIELD, CT, 06877-0368, US

(73) Assignee: Boehringer Ingelheim International GmbH, Ingelheim (DE)

(21) Appl. No.: 11/254,310

(22) Filed: Oct. 20, 2005

(51) Int. Cl. B29C 49/00

(52) U.S. Cl. 264/523

(57) ABSTRACT

A process is described, for preparing a container provided with a container opening, having a substantially inherently rigid outer layer and at least one inner layer, each of a different thermoplastic plastics material. First of all a preform of at least two coaxial molten polymer tubes (2,3) which are of a sufficient length to produce the container is produced in a blow-molding method between the closed individual parts of a blow-mold (4). The rigid inflating mandrel (5) with a balloon (6) mounted thereon is passed through the mold into the interior of the preform, after which the balloon (6) is inflated in the region of the container opening, such that the minimum of two layers are pressed against the blow-mold (4) and hardened there. Finally, pressure is introduced through the inflating mandrel (5) into the interior of the preform.

### BACKGROUND OF THE INVENTION

The present invention relates to a process for producing a container provided with a container opening having a substantially inherently rigid outer layer and at least one inner layer, each consisting of a different thermoplastic synthetic material.

The process is particularly suitable for producing a container as described in German Patent Application No. 100 17 443, which is incorporated herein by reference in its entirety.

In the process, first of all a preform is produced consisting of at least two coaxial molten polymer tubes which are of sufficient length to produce the container. The production of the container is then carried out by a blowing process between the closed individual parts of a blow-mold, with an inflating mandrel projecting through the mold into the molten preform.

Precisely at this moment problems may arise with the blow-mold in the region of the container opening that is to be formed. Namely, if the layers of thermoplastic plastics are not arranged parallel over one another but have generally been pushed into one another, this leads to undesirable weakening of the neck area of the container, which may cause leaky areas. The tubes, of which the outer tube consists of polypropylene, for example and the inner tube consists of polyethylene, for example, are negatively affected by the pressure introduced into the interior through an inflating mandrel, unless particular action is taken. This applies particularly to the inner tube in the region of the container opening. Whereas the outer tube may have wall thicknesses of between 0.3 and 2 mm, for example, the inner tube will have a wall thickness of from 0.08 to 0.5 mm, for example. If this material is then subjected to the pressure mentioned above, as a result of, among other things, shifts in the areas of the inner and outer layers located on one another before the blowing process, there may be damage to the inner wall in the neck region between the inner tube and the inflating mandrel, such as a thinning of the tube material down to a thickness of 0.01 mm, for example, or even holes. In addition, inhomogeneities are formed in the wall thickness of the inner tube in the region of the neck of the container. However, such thinning results in problems with regard to leaktight properties. If the container is not leaktight, liquid can escape at these points. In the regions with a thinner wall thickness the diffusion barrier is also reduced with the result that highly volatile substances are better able to diffuse out at this point.

### SUMMARY OF THE INVENTION

Against this background the aim of the present invention is to further develop the process mentioned hereinbefore so that thinning of the walls of the tubes is substantially prevented. Thus, a process is to be specified which solves the problem of thinning, particularly of the inner layer in the neck region of the container. A container produced by the process will also be described. Three alternative proposals will be put forward for the process.

### BRIEF DESCRIPTION OF THE DRAWINGS

The invention is explained more fully with reference to an exemplifying embodiment according to the drawings.

FIG. 1 is a diagrammatic side elevation of the arrangement of two plastic tubes in a blow-mold with the inflating mandrel inserted in the neck region of the container which is to be formed,

FIG. 2 shows the blow-mold and inflating mandrel of FIG. 1 with the balloon inflated therein, and

FIG. 3 shows the blow-mold and inflating mandrel of FIG. 1 after the entire preform has been subjected to pressure. In the drawings, identical parts have been given the same reference numerals.

### DESCRIPTION OF THE INVENTION

According to the first option it is proposed that, once the blow-mold has been closed as described, a rigid inflating mandrel with a balloon mounted thereon is passed through the container opening into the interior of the preform, the balloon is inflated in the region of the container opening such that the minimum of two layers are pressed against the blow-mold where they harden, and finally pressure is introduced into the interior of the preform through the inflating mandrel.

Thus, in this case, the problem outlined is solved by first pressing the plastic layers in controlled manner against the blow-mold in the region of the neck of the container to be produced, using the inflated balloon. Only when this step has been completed is the remainder of the container inflated and the container shaped so that the plastic layers fit closely against the blow-mold in the other areas as well and harden therein. This proposed method ensures that the plastic layers are to some extent fixed first of all in the region of the container opening before the other parts of the container are shaped, as a result of which no further influence can be exerted on the plastic layers in the neck region of the container as these layers have already hardened in the desired shape.

The balloon may be attached to the inflating mandrel by a suitable method, e.g., by adhesive bonding.

According to a second proposal—again once the blow-mold has been closed—a rigid inflating mandrel with a balloon accommodated in the mandrel is passed into the region of the container opening, the balloon is inflated in the region of the container opening, thereby leaving the inflating mandrel, so that the minimum of two layers are pressed against the blow-mold where they harden, and finally the inflating mandrel is optionally guided deeper into the interior of the preform and then more air pressure is passed through the inflating mandrel into the interior of the preform.

Thus, in contrast to the first variant, the balloon is first of all located inside the inflating mandrel before being inflated by the introduction of air and performs the same function as the balloon in the first variant. Here, too, the layers of plastic are fixed beforehand in the region of the container opening so as to harden in this state so that no movements or the like which could lead to thinning of the inner layer are possible.

To make it easier to insert the unit comprising the inflating mandrel and balloon into the container opening, it may be envisaged according to an advantageous feature that a vacuum be produced in the balloon before the inflating mandrel is inserted. This improves the introduction characteristics as the possibility of the balloon material snagging on edges of the container opening is reduced.

The temperature of the air with which the balloon is inflated is preferably below ambient temperature (i.e., the temperature of the environment surrounding the balloon). This causes the cooling of the plastics material during inflation of the two tubes to proceed more rapidly. As a result the throughput of the blow-mold can be increased.

Preferably the balloon is inflated with a higher pressure than the rest of the preform. This step reliably prevents the balloon from being compressed by a higher pressure in the preform and in certain circumstances resulting in displacement or thinning of the inner tube.

Preferably, a polytetrafluoroethylene-coated balloon may be used. This reduces the adhesive friction and ensures that the balloon is easily detached once the container is finished. Alternatively, a silicone-coated balloon or a balloon with a metallized surface may be used. All these measures assist with the easy removal of the balloon from the container opening after the production of the container.

The material used for the balloon may also be a composite material consisting of metal components in a polymer matrix.

According to a third variant of the process, once the blow-mold has been closed, a resilient inflating mandrel with an inlet larger than its outlet is passed through the container opening into the interior of the preform and is subjected to pressure such that the inflating mandrel in the region of the container opening presses the minimum of two layers against the blow-mold before the pressure reaches the remainder of the preform. Thus, in this variant, there is no rigid inflating mandrel as in the first two variants but rather a resilient inflating mandrel is used which is specially constructed so that it is inflated to some extent in the region of the container opening to begin with, in order to fix the two layers on the blow-mold before pressure can be introduced into the rest of the preform on account of the flow conditions. The flow conditions arise, inter alia, from the fact that the inlet of the inflating mandrel is larger than its outlet.

One advantage of this third variant, in addition to others, is that there is no need to produce a vacuum to assist the insertion into the container opening. To some extent the resilient inflating mandrel forms its own balloon when pressure is applied.

With respect to the container produced by means of the three alternative forms of the process, the wall of the balloon is advantageously made up of layers of rubber and polyolefins.

Alternatively, the container of multi-layered wall construction consists of layers of rubbers and polyurethane in the form of thermoplastic elastomers.

In a preferred embodiment the rubbers are selected from the following group:

Hydrogenated nitrile-butadiene rubber (HNBR), ethylene-propylene-(diene) rubbers (EPDM), silicone rubbers, methyl-phenyl-vinyl rubber (MPVQ), methyl-phenyl-silicomethane rubber (MPQ).

Alternatively, it is preferably envisaged that the polyolefins are selected from among the following group:

low density polyethylene (LDPE), linear low density polyethylene (LLDPE), high density polyethylene (HDPE), high molecular weight polyethylene (HMWPE), ultra high molecular weight polyethylene (UHMWPE), polypropylene and the copolymers, derivatives and blends thereof.

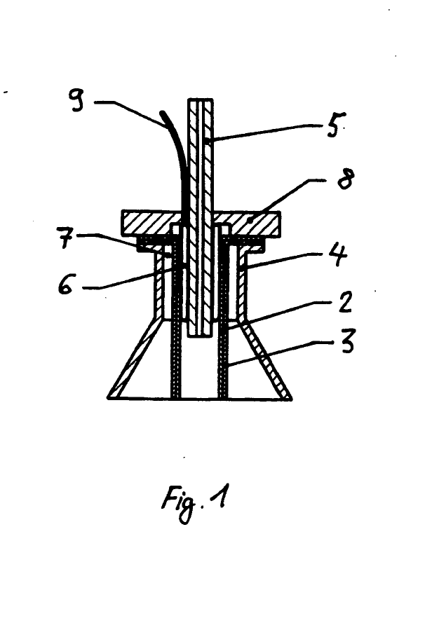

FIG. 1 shows the initial situation before the co-extrusion blow-molding has been carried out.

Two coaxial tubes 2, 3 are passed into a blow-mold 4 from above. The tubes 2, 3 are still at a certain spacing from the walls of the blow-mold 4. An inflating mandrel 5 is passed into the coaxial tubes 2, 3 from above and also passes through the cutting plate 8. The cutting plate 8 serves to form the container opening 7.

A balloon 6 which has not yet been inflated in FIG. 1 is mounted on the rigid inflating mandrel 5. This balloon 6 can be inflated with compressed air introduced through the compressed air line 9.

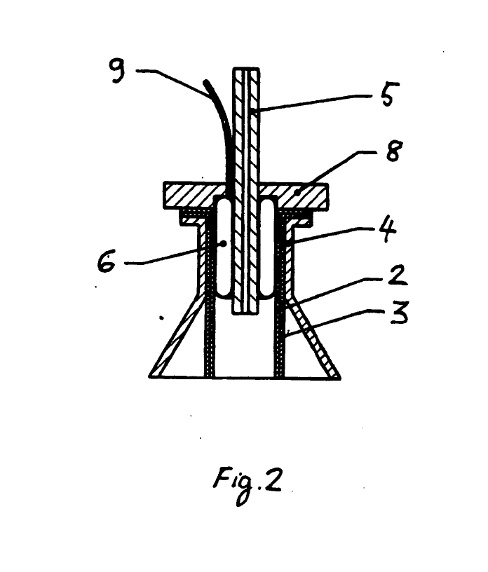

A snapshot of this moment is shown in FIG. 2. The balloon 6 is clearly shown as being inflated so that the two tubes 2 and 3 are pressed against the walls of the blow-mold 4 where they harden. In this way the container opening of the container is fully formed before compressed air is introduced into the interior of the preform through the inflating mandrel 5. This prevents thinning particularly of the inner tube 2.

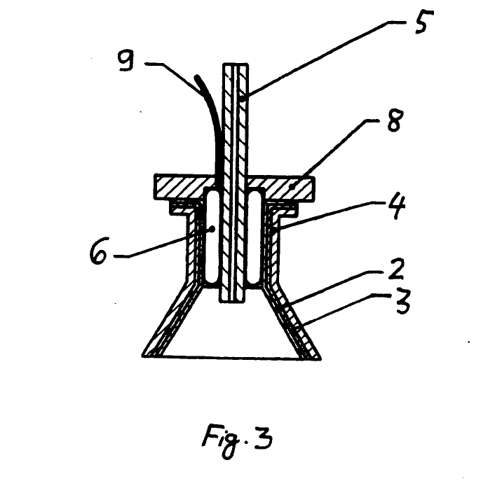

This moment is recorded in FIG. 3. The balloon 6 is still inflated and air has been passed into the remainder of the preform through the inflating mandrel 5, as indicated by the fact that the tubes 2 and 3 have been pressed against the walls of the blow-mold 4 even in the areas behind the container opening.

The air is then let out of the balloon 6 or preferably a vacuum is generated in the balloon 6. The machine component consisting of inflating mandrel 5, balloon 6 and cutting plate 8, which is to be moved as a single unit, can then be withdrawn from the container opening and the blow-mold 4 can be opened to remove the molded container.

What is claimed is:

1. A process for producing a container comprising a container opening (7) having a substantially inherently rigid outer layer and an inner layer, the layers consisting of different thermoplastic synthetic materials, the process comprising:
A. providing a preform between closed individual parts of a blow-mold (4), the preform comprising of at least two coaxial molten polymer tubes (2,3) that are of sufficient length to produce a container
B. passing a rigid inflating mandrel (5) with a balloon (6) mounted thereon through the blow-mold into the interior of the preform,
C. inflating the balloon (6) in the region of the container opening (7), whereby the layers are pressed against the blow-mold (4) and harden there, and
D. introducing pressure into the interior of the preform through the inflating mandrel (5).

2. The process according to claim 1, wherein a vacuum is generated in the balloon (6) before the inflating mandrel (5) is introduced.

3. The process according to claim 1, wherein the balloon (6) is inflated with air, the temperature of which is below the ambient temperature.

4. The process according to claim 1, wherein the balloon (6) is inflated with a higher pressure than the rest of the preform.

5. The process according to claim 1, wherein the balloon (6) is coated with polytetrafluoroethylene or silicone.

6. The process according to claim 1, wherein the balloon (6) comprises a metal.

7. A process for producing a container comprising a container opening (7) having a substantially rigid outer layer and an inner layer, the layers consisting of different thermoplastic synthetic materials, the process comprising:
A. providing a preform between the closed individual parts of a blow-mold (4), the preform comprising of at least two coaxial molten polymer tubes (2,3) that are of sufficient length to produce a container,
B. passing a rigid inflating mandrel (5) with a balloon (6) accommodated therein into the region of the container opening (7),
C. inflating the balloon (6) in the region of the container opening (7), whereby the layers are pressed against the blow-mold (4) and harden there,
D. passing the inflating mandrel into the interior of the perform, and
E. introducing pressure into the interior of the perform through the inflating mandrel (5).

8. The process according to claim 7, wherein a vacuum is generated in the balloon (6) before the inflating mandrel (5) is introduced.

9. The process according to claim 7, wherein the balloon (6) is inflated with air, the temperature of which is below the ambient temperature.

10. The process according to claim 7, wherein the balloon (6) is inflated with a higher pressure than the rest of the preform.

11. The process according to claim 7, wherein the balloon (6) is coated with polytetrafluoroethylene or silicone.

12. The process according to claim 7, wherein the balloon (6) comprises a metal.

13. A process for producing a container comprising a container opening (7) having a substantially rigid outer layer and an inner layer, the layers consisting of different thermoplastic synthetic materials, the process comprising:
A. providing a preform between the closed individual parts of a blow-mold (4), the preform comprising of at least two coaxial molten polymer tubes (2,3) that are of sufficient length to produce a container;
B. passing a resilient inflating mandrel (5) with an inlet larger than the outlet through the mold into the interior of the perform; and
C. introducing pressure through the inflating mandrel (5), whereby the inflating mandrel (5) in the region of the container opening (7) presses the layers against the blow-mold (4) before the pressure has reached the remainder of the preform.

14. The process according to claim 13, wherein a vacuum is generated in the balloon (6) before the inflating mandrel (5) is introduced.

15. The process according to claim 13, wherein the balloon (6) is inflated with air, the temperature of which is below the ambient temperature.

16. The process according to claim 13, wherein the balloon (6) is inflated with a higher pressure than the rest of the preform.

17. The process according to claim 13, wherein the balloon (6) is coated with polytetrafluoroethylene or silicone.

18. The process according to claim 13, wherein the balloon (6) comprises a metal.
